(19) United States
(12) Patent Application Publication
(10) Pub. No.: US 2026/0192704 A1
(43) Pub. Date: Jul. 9, 2026

(54) APPARATUS AND METHOD FOR BATTERY CELL BALANCING

(71) Applicant: GM Global Technology Operations LLC, Detroit, MI (US)

(72) Inventors: Mohamed Kamel, Birmingham, MI (US); Jun-mo Kang, Ann Arbor, MI (US)

(21) Appl. No.: 19/009,023

(22) Filed: Jan. 3, 2025

(51) Int. Cl. B60L 58/22; B60L 58/12; H01M 10/42

(52) U.S. Cl. CPC B60L 58/22; B60L 58/12; H01M 10/425; H01M 2010/4271

(57) ABSTRACT

A system performs a method of balancing battery cells of a battery pack. The system includes a plurality of battery managers, a plurality of regulators and a processor. The battery cells are grouped into a plurality of groups. A battery manager estimates a state of charge (SOC) of a battery cell. A regulator controls a group. The processor identifies a target battery cell having a global minimum SOC (target SOC), identifies a target group that includes the target battery cell and a non-target group that does not include the target battery cell, and balances the battery cells by reducing the SOC of the non-target group until a minimum SOC of the non-target group is equal to the target SOC by removing a same SOC from each battery cell in the non-target group and adjusting the SOCs within the non-target group to meet a selected group target for the non-target group.

The subject disclosure relates to vehicles and, in particular, to a method and system for balancing a battery pack of the vehicle.

An electric vehicle includes a battery pack for operation of the motor and other electrical components of the vehicle. A battery pack includes a plurality of battery modules. Each battery module includes a plurality of battery cells. Each battery cell has a state of health, which can change for each battery cell during operation of the electric vehicle. The state of health can be defined by various parameters, including a state of charge. When the states of charge of the battery cells differ significantly from each other, the state of health of the battery pack declines. Accordingly, it is desirable to provide a system and method for balancing the battery cells of the battery pack.

### SUMMARY

In one exemplary embodiment, a method of balancing battery cells in a battery pack is disclosed. A state of charge (SOC) of each battery cell of the battery pack is estimated, wherein the battery cells are grouped into a plurality of groups. A target battery cell is identified having a global minimum SOC from amongst the battery cells, wherein the global minimum SOC is a target SOC. A target group is identified from the plurality of groups that includes the target battery cell. A non-target group is identified that does not include the target battery cell. The battery cells are balanced by reducing the SOC of the battery cells of the non-target groups until a minimum SOC of the non-target group is equal to the target SOC by removing a same SOC from each battery cell in the non-target group and adjusting the SOC of the battery cells within the non-target group to meet a selected group target for the non-target group.

In addition to one or more of the features described herein, the non-target group includes multiple non-target groups, further including reducing the SOC of the battery cells of the non-target group until the minimum SOC of the non-target group is equal to the target SOC by one of reducing the SOC of the battery cells of each non-target group simultaneously and reducing the SOC of the battery cells in each non-target group in an order from the non-target group having a highest minimum SOC to the non-target group having a lowest minimum SOC.

In addition to one or more of the features described herein, adjusting the SOCs of the non-target group to meet the selected group target further includes one of reducing each SOC of the non-target group to the target SOC adjusting the SOC of each battery cell of the non-target group to a group average.

In addition to one or more of the features described herein, reducing each SOC of the non-target group to the target SOC further includes one of reducing the SOCs simultaneously and reducing the SOCs in an order from a maximum SOC to a minimum SOC.

In addition to one or more of the features described herein, the battery pack includes four battery groups and each battery group including three battery cells.

In addition to one or more of the features described herein, the method further includes operating a battery manager to control a configuration of a switch at a selected battery cell and operating a regulator to control operation of a converter associated with a selected group.

In addition to one or more of the features described herein, the method further includes identifying a maximum SOC of the battery pack and a minimum SOC of the battery pack and balancing the battery pack when a difference between the maximum SOC and the minimum SOC is greater than a threshold.

In another exemplary embodiment, a system for balancing battery cells of a battery pack is disclosed. The system includes a plurality of battery managers, a plurality of regulators and a processor. Each battery manager is configured to estimate a state of charge (SOC) of a battery cell of the battery pack, wherein the battery cells are grouped into a plurality of groups. Each regulator is configured to control a group of the plurality of groups. The processor is configured to identify a target battery cell having a global minimum SOC from amongst the battery cells, wherein the global minimum SOC is a target SOC, identify a target group from the plurality of groups that includes the target battery cell, identify a non-target group that does not include the target battery cell, and balancing the battery cells by reducing the SOC of the battery cells of the non-target group until a minimum SOC of the non-target group is equal to the target SOC by removing a same SOC from each battery cell in the non-target group and adjusting the SOC of the battery cells within the non-target group to meet a selected group target for the non-target group.

In addition to one or more of the features described herein, the non-target group includes multiple non-target groups and the processor is further configured to reduce the SOC of the battery cells of the non-target group until the minimum SOC of the non-target group is equal to the target SOC by performing one of reducing the SOC of the battery cells of each non-target group simultaneously and reducing the SOC of the battery cells in each non-target group in an order from the non-target group having a highest minimum SOC to the non-target group having a lowest minimum SOC.

In addition to one or more of the features described herein, the processor is further configured to adjust the SOCs of the non-target group to meet the selected group target by performing one of reducing each SOC of the non-target group to the target SOC and adjusting the SOC of each battery cell of the non-target group to a group average.

In addition to one or more of the features described herein, the processor is further configured to reduce each SOC of the non-target group to the target SOC by performing one of reducing the SOCs simultaneously and reducing the SOCs in an order from a maximum SOC to a minimum SOC.

In addition to one or more of the features described herein, the battery pack includes four battery groups and each battery group including three battery cells.

In addition to one or more of the features described herein, the processor is further configured to operate a battery manager selected from the plurality of battery managers to control a configuration of a switch at a selected battery cell and operate a regulator selected from the plurality of regulators to control operation of a converter associated with a selected group.

In addition to one or more of the features described herein, the processor is further configured to identify a maximum SOC of the battery pack and a minimum SOC of the battery pack and balance the battery pack when a difference between the maximum SOC and the minimum SOC is greater than a threshold.

In another exemplary embodiment, a vehicle is disclosed. The vehicle includes a vehicle controller and a processor. The vehicle controller is in communication with a plurality of battery managers and a plurality of regulators, each battery manager configured to estimate a state of charge (SOC) of a battery cell of the battery pack, wherein the battery cells are grouped into a plurality of groups and a plurality of regulators, each regulator configured to control a group of the plurality of groups. The processor is configured to identify a target battery cell having a global minimum SOC from amongst the battery cells, wherein the global minimum SOC is a target SOC, identify a target group from the plurality of groups that includes the target battery cell, identify a non-target group that does not include the target battery cell, and balance the battery cells by reducing the SOC of the battery cells of the non-target group until a minimum SOC of the non-target group is equal to the target SOC by removing a same SOC from each battery cell in the non-target group and adjusting the SOC of the battery cells within the non-target group to meet a selected group target for the non-target group.

In addition to one or more of the features described herein, the non-target group includes multiple non-target groups and the processor is further configured to reduce the SOC of the battery cells of the non-target group until the minimum SOC of the non-target group is equal to the target SOC by performing one of reducing the SOC of the battery cells of each non-target group simultaneously and reducing the SOC of the battery cells in each non-target group in an order from the non-target group having a highest minimum SOC to the non-target group having a lowest minimum SOC.

In addition to one or more of the features described herein, the processor is further configured to adjust the SOCs of the non-target group to meet the selected group target by performing one of reducing each SOC of the non-target group to the target SOC and adjusting the SOC of each battery cell of the non-target group to a group average.

In addition to one or more of the features described herein, the processor is further configured to reduce each SOC of the non-target group to the target SOC by performing one of reducing the SOCs simultaneously and reducing the SOCs in an order from a maximum SOC to a minimum SOC.

In addition to one or more of the features described herein, the battery pack includes four battery groups and each battery group including three battery cells.

In addition to one or more of the features described herein, the processor is further configured to operate a battery manager selected from the plurality of battery managers to control a configuration of a switch at a selected battery cell and operate a regulator selected from the plurality of regulators to control operation of a converter associated with a selected group.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an embodiment of a vehicle in accordance with an exemplary embodiment;

FIG. 2 shows an electrical system of the vehicle, in an embodiment;

FIG. 3 is a block diagram depicting a control system for controlling the state of the battery pack, in an embodiment;

FIG. 4 is a flowchart of a first method for adjusting the SOCs of the battery cells of a battery pack, in one embodiment;

FIG. 5 is a graph showing a state of charge (SOC) for each of the battery cells of the battery pack with the battery cells clustered into groups including a target group and a non-target group;

FIG. 6 is a graph showing a first step in which a non-target group is reduced;

FIG. 7 is a graph showing a second step in which a non-target group is reduced;

FIG. 8 is a graph showing a third step in which a non-target group is reduced;

FIG. 9 is a graph showing a first step in the individual cell minimization stage;

FIG. 10 is a graph showing a second step in the individual cell minimization stage;

FIG. 11 is a graph showing a third step in the individual cell minimization stage;

FIG. 12 is a graph showing a fourth step in the individual cell minimization stage;

FIG. 13 is a graph showing a fifth step in the individual cell minimization stage;

FIG. 14 is a graph showing a sixth step in the individual cell minimization stage;

FIG. 15 is a graph showing a seventh step in the individual cell minimization stage;

FIG. 16 is a graph showing an eighth step in the individual cell minimization stage;

FIG. 17 is a flowchart of a second method for adjusting the SOCs of the battery cells of a battery pack, in one embodiment;

FIG. 18 is a graph showing a first step of the group average equalization stage;

FIG. 19 is a graph showing a second step of the group average equalization stage;

FIG. 20 is a graph showing a third step of the group average equalization stage; and

FIG. 21 is a graph showing a fourth step of the group average equalization stage.

### DETAILED DESCRIPTION

The following description is merely exemplary in nature and is not intended to limit the present disclosure, its application or uses. It should be understood that throughout the drawings, corresponding reference numerals indicate like or corresponding parts and features.

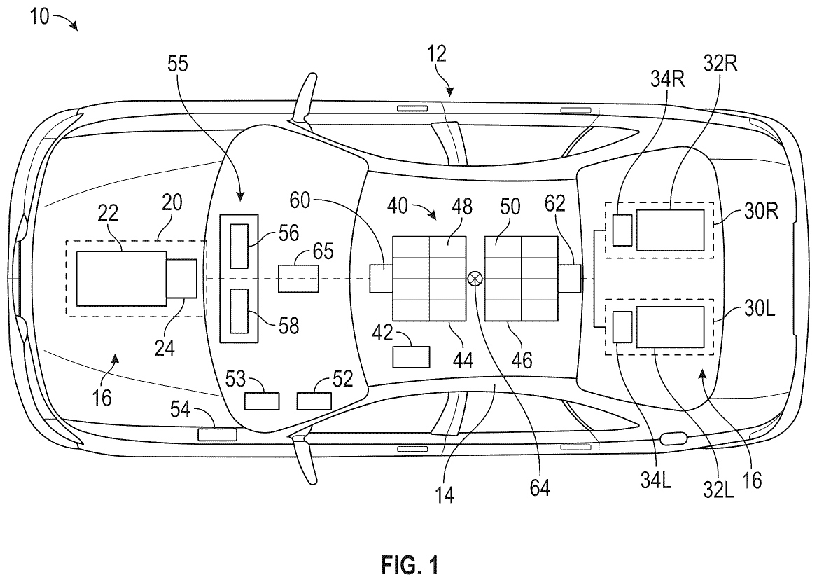

In accordance with an exemplary embodiment, FIG. 1 shows an embodiment of a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an alternative embodiment, the vehicle 10 can be a hybrid vehicle, etc. In an embodiment, the vehicle 10 is an electric vehicle that includes multiple motors and/or drive systems. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes a left rear electric motor 32L and a left rear inverter 34L. A right rear drive unit 30R includes a right rear electric motor 32R and a right rear inverter 34R. The front inverter 24, left rear inverter 34L and right rear inverter 34R (e.g., power inverter units or PIMs) each convert direct current (DC) power from a high voltage (HV) battery system 40 to poly-phase (e.g., two-phase, three-phase, six-phase, etc.) alternating current (AC) power to drive the front electric motor 22 the left rear electric motor 32L and the right rear electric motor 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives the front wheels (not shown), and the left rear electric motor 32L and right rear electric motor 32R drive the rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to the battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

In an embodiment, the battery system 40 includes a plurality of separate battery assemblies, in which each battery assembly can be independently charged and can be used to independently supply power to a drive system or systems. For example, the battery system 40 includes a first battery assembly such as a first battery pack 44 connected to the front inverter 24, and a second battery pack 46. The first battery pack 44 includes a first plurality of battery modules 48, and the second battery pack 46 includes a second plurality of battery modules 50. Each of the first plurality of battery modules 48 and the second plurality of battery modules 50 includes a number of individual cells (not shown).

Each of the front electric motor 22 and the left rear electric motor 32L and right rear electric motor 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the first battery pack 44 and second battery pack 46, and selectively connecting the first battery pack 44 and second battery pack 46 to the front drive unit 20, left rear drive unit 30L and right rear drive unit 30R. The switching devices may also be operated to selectively connect the first battery pack 44 and the second battery pack 46 to a charging system. The charging system can be used to charge the first battery pack 44 and the second battery pack 46, and/or to supply power from the first battery pack 44 and/or the second battery pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply. A second OBCM 53 may be included for DC charging (e.g., DC fast charging or DCFC).

In an embodiment, the switching system includes a first switching device 60 that selectively connects to the first battery pack 44 to the front inverter 24, left rear inverter 34L and right rear inverter 34R, and a second switching device 62 that selectively connects the second battery pack 46 to the front inverter 24, left rear inverter 34L and right rear inverter 34R. The switching system also includes a third switching device 64 (also referred to as a “battery switching device”) for selectively connecting the first battery pack 44 to the second battery pack 46 in series.

Any of various controllers can be used to control functions of the battery system 40, the switching system and the drive units. A controller includes any suitable processing device or unit, and may use an existing controller such as a drive system controller, an RESS controller, and/or controllers in the drive system. For example, a controller 65 may be included for controlling switching and drive control operations as discussed herein.

The vehicle 10 also includes a computer system 55 that includes one or more processing devices 56 and a user interface 58. The computer system 55 may communicate with the charging system controller, for example, to provide commands thereto in response to a user input. The various processing devices, modules and units may communicate with one another via a communication device or system, such as a controller area network (CAN) or transmission control protocol (TCP) bus.

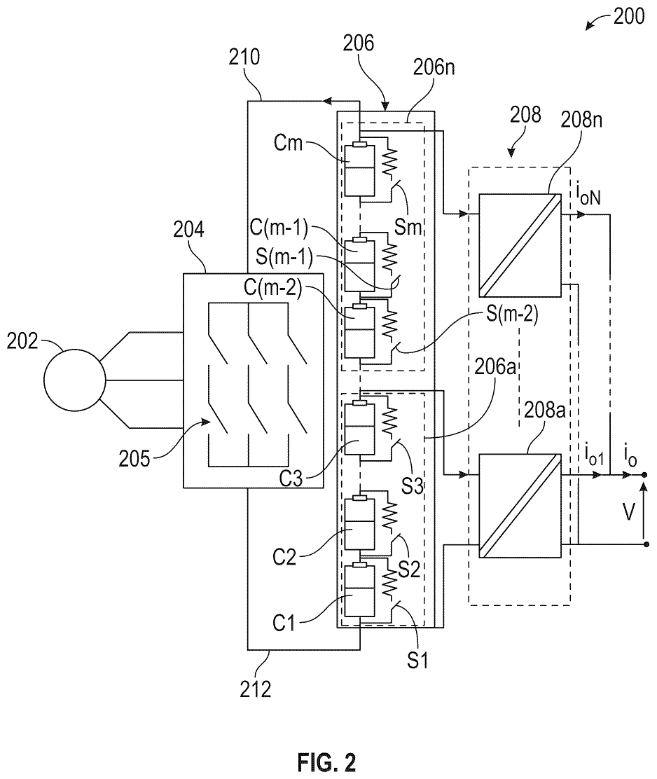

FIG. 2 shows an electrical system 200 of the vehicle 10, in an embodiment. The electrical system 200 includes a motor 202, an inverter 204, a battery pack 206 and a plurality of DC/DC converters 208a-208n. The inverter 204 includes switches 205 which can be closed in various configurations to connect the battery pack 206 to the motor 202 to operate the motor. The switches can also be opened to disconnect the motor 202 from the battery pack 206.

The battery pack 206 includes a plurality of modules 206a-206n. For illustrative purposes, the battery pack 206 includes 4 modules (i.e., n=4). Each of the plurality of modules 206a-206n includes a plurality of battery cells. For illustrative purposes, each module includes three battery cells. As shown in FIG. 2, module 206a includes battery cells C₁, C₂ and C₃ and module 206n includes battery cells C₍ₘ₋₂₎, C₍ₘ₋₁₎ and Cₘ. The cells within each module are aligned in series. The modules 206a-206n are aligned in series between a positive bus 210 and a negative bus 212. Therefore, the battery cells C₁-Cₘ are aligned in series between the positive bus 210 and the negative bus 212. Each battery cell C₁-Cₘ has an associated switch S₁-Sₘ across it that can be opened to place the cell into the circuit or closed to remove the cell from the circuit.

Each module 206a-206n has an associated DC/DC converter 208a-208n which regulates the module. As shown in FIG. 2, module 206a is associated with a first DC/DC converter 208a and module 206n is associated with an n^{th} DC/DC converter 208n.

The battery cells can be in different states of health. For example, battery cell C1 can have a low state of charge and battery cell C3 can have a high state of charge. The low state of charge of C1 can impede the ability to discharge the battery cells as a group, while the high state of charge of C3 can impede the ability to charge the battery cells as a group. However, the switches S₁-Sₘ can be configured to individually select a battery cell (or a group of battery cells) for charging or discharging. The voltage across an n^{th} battery cell can be measured and used to calculate an amount of charge or discharge that is performed at the n^{th} battery cell, as shown in Eq. (1):

$$Δ {q}_{N} = - {\int }_{0}^{{T}_{o n}} \frac{{V}_{N}}{{R}_{b}} d t \qquad Eq . ( 1 )$$

where Vₙ is the voltage of the N^{th} battery cell, R_{b} is the resistance across the N^{th} battery cell, Tₒₙ is an amount of time for which the charging (or discharging) occurs at the battery cell.

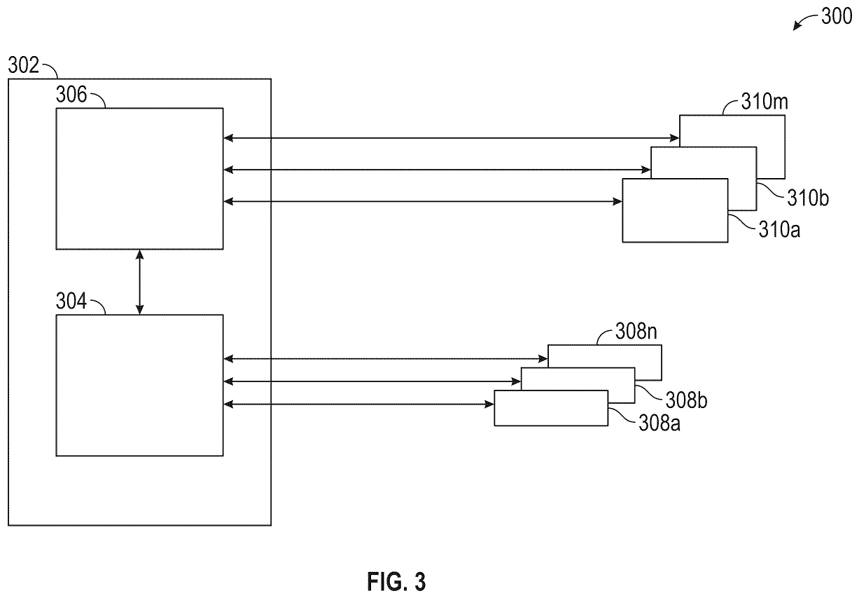

FIG. 3 is a block diagram depicting a control system 300 for controlling the state of the battery pack, in an embodiment. The control system 300 includes a vehicle controller 302 having a power controller 304 and a battery controller 306 that are in communication with each other. The power controller 304 communicates with regulators 308a-308n of the electrical system. The regulators 308a-308n communicate target currents and target voltages to the power controller 304. The power controller 304 sends signals to the regulators 308a-308n to control the current or voltage at the modules. Each of the regulators 308a-308n controls a corresponding one of the DC/DC converter 208a-208n.

The battery controller 306 communicates with the battery managers 310a-310m. Each of the battery managers 310a-310m is associated with a corresponding battery cell C1-Cm and controls the configuration of the switch associated with the corresponding battery cell.

The battery managers 310a-310m measure and monitor the voltages levels of each cell and provide this to the battery controller 306. The battery controller 306 determines or estimates a state of health parameter (i.e., state of charge (SOC), voltage, current, temperature, etc.) for the battery cells and sends commands to the battery managers 310a-310m to configure the switches to select one or more battery cells for charging or discharging.

The SOCs of the battery cells are continuously monitored. A maximum SOC and a minimum SOC can be estimated and a difference between the maximum SPC and the minimum SOC can be calculated. If the difference is less than or equal to a calibratable threshold, the battery pack is considered to be in balance. If the difference is greater than the calibratable threshold, a balancing method can be performed, as disclosed herein. An amount of SOC spread can be determined between the groups. The method can include calculating an amount of charge needed to be removed from each group to bring the groups into balance.

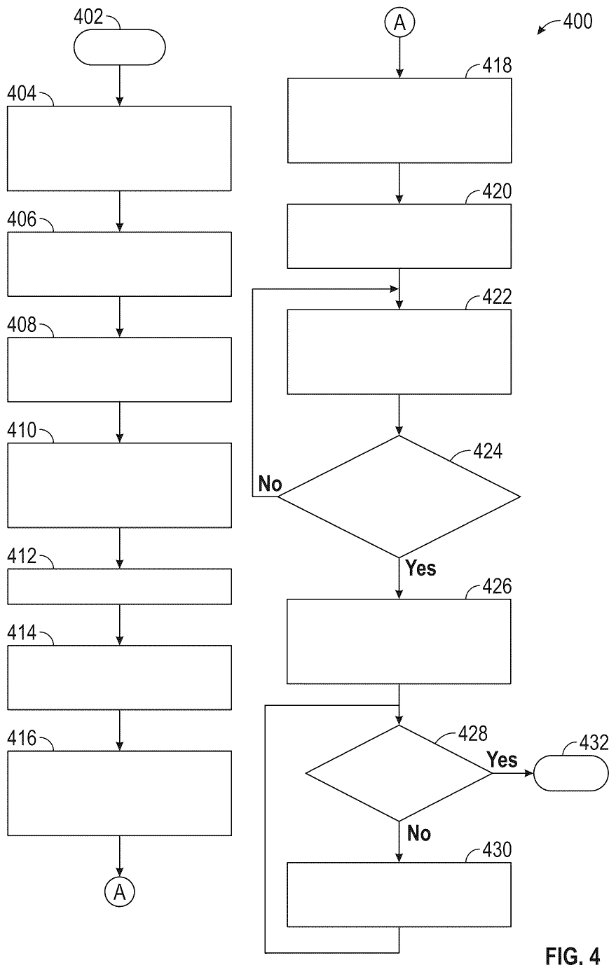

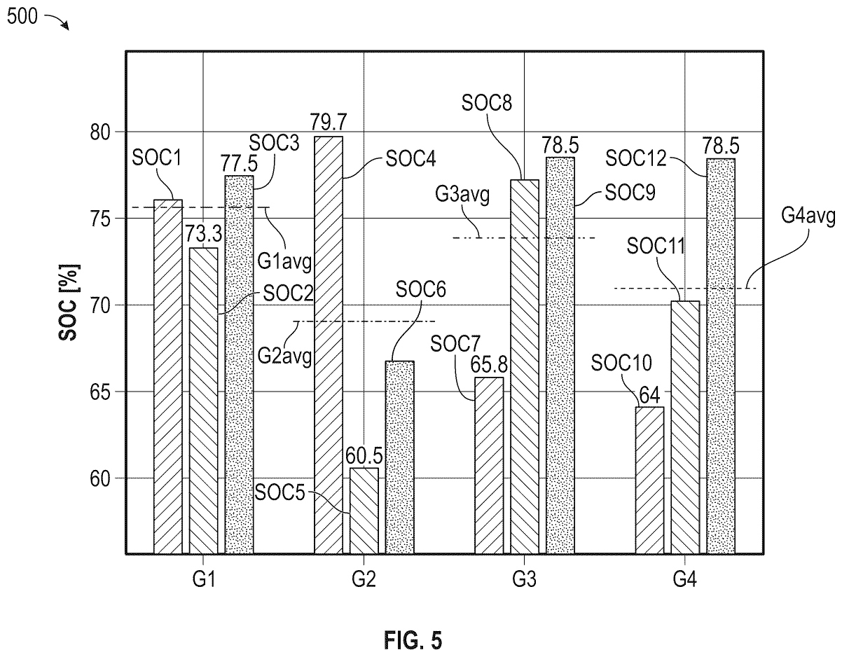

The control system 300 can perform various operations to control the state of health of the battery pack. For illustrative purposes, the state of health is indicated by the state of charge (SOC). In a first operation, a target SOC (or a target battery cell having the target SOC) is identified amongst the battery cells and a target group is identified that includes the target battery cell. The SOCs of the remaining cells or non-target battery cells can then be adjusted to that of the target SOC, as disclosed herein. In particular, for each non-target group, the SOCs of the battery cells can be adjusted until the SOC of one of the battery cells in in the non-target group matches the target SOC. This affects the average value of the SOC for the non-target group. Then, the SOCs of the remaining battery cells in the non-target group can be adjusted until they match the target SOC. As a result of this operation, all of the cells have the same SOC (i.e., the target SOC). A flow chart for this first operation is shown in FIG. 4 and an illustration of the evolution of SOCs due to the first operation is shown with respect to FIGS. 5-16.

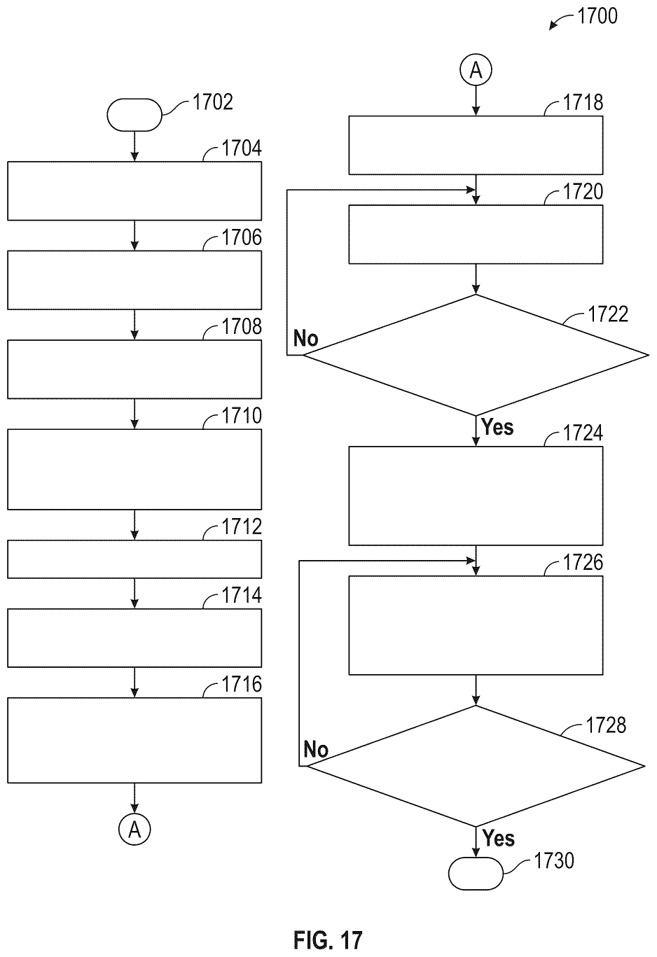

In a second operation, the target SOC and target group is identified. For each non-target group, the SOCs of the battery cells can be adjusted until the SOC of one of the battery cells in the non-target group matches the target SOC. This affects the average value of the SOC for the non-target group. Then for each battery group, the SOCs can be adjusted to the average value. As a result, each battery cell of a group is set at the same SOC value, but the SOC of a battery cell in one group is not necessarily the same as the SOC of a battery cell in another group and is most likely different. A flow chart for this first operation is shown in FIG. 17 and an illustration of the evolution of SOCs due to the first operation is shown with respect to FIGS. 5-8 and 18-21.

FIG. 4 is a flowchart 400 of a first method for adjusting the SOCs of the battery cells of a battery pack, in one embodiment. The method starts at box 402. In box 404, background functions of the battery controller 306 are initiated. Initiation includes performing checks, handshakes, etc. In box 406, the regulators 308a-308n are initialized at default parameters for controlling the DC/DC converters. In box 408, the battery managers 310a-310m are initialized at default parameters for controlling switches and battery selection. Once initialized, the regulators and battery managers are operated in the background for the remainder of the method, thereby providing the data for subsequent steps. In box 410, battery parameters (e.g., voltage, current, temperature) are acquired or sensed using the battery managers 310a-310m. In box 412, the battery controller 306 estimates the battery states (e.g., SOC, state of health (SOH)) for each battery cell based on the battery parameters. In box 414, a target battery state is identified. The target battery state can be a global minimum SOC of the battery cells. The battery cell that has the target battery state is identified as a target battery. In box 416, the group that includes the target battery is identified as the target group.

In box 418, a target state (target SOC) is identified from each battery in the same group (such as the non-target groups). In box 420, a desired mode of operation of a regulator is determined. This includes determining various parameters of the regulators, such as a charging time (Tₒₙ), a reference current (I_{ref}), a reference voltage (V_{ref}), a charging time limit (Tₗᵢₘᵢₜ) and a power limit (Pₗᵢₘᵢₜ). In box 422, the regulators are selected and enabled (while the battery states are enabled). The regulators adjust the battery cells of each group by a same amount until a condition is met, such as the minimum SOC of the group matching the target SOC. In box 424, the condition is checked. If the condition has not been met, the method loops back to box 422. If the condition has been met, the method proceeds to box 426.

In box 426, a unique or individual target is set for each battery group. The individual target can be that the SOC of each battery of the group is set to the current average SOC of the group. In box 428, the groups are monitored to determine if the individual targets have been met for each battery group. If the targets have not been met, the method proceed to box 430. In box 430, the battery managers are updated to control the individual charging or discharging of the batteries within the battery groups. The method then loops back to box 428. In box 428, if the individual targets have been met, the method proceeds to box 432. In box 432, the method ends.

FIG. 5 shows a graph 500 of state of charge (SOC) for each of the battery cells of the battery pack. For illustrative purposes, the SOCs are grouped into four groups (G1, G2, G3, G4) corresponding to four battery modules (206a, 206b, 206c, 206d). Each group has three SOCs. Each SOC (SOC1-SOC12) is associated with a corresponding battery cell (C1-C12). Group G1 includes SOC1-SOC3. Group G2 includes SOC4-SOC6. Group G3 includes SOC7-SOC9. Group G4 includes SOC10-SOC12. Each group has an average SOC that is the average of the SOCs in the group, as indicates by G1_{avg}, G2_{avg}, G3_{avg} and G4_{avg}. At the beginning of the procedure G1_{avg}=75.6%, G2_{avg}=69%, G3_{avg}=73.8%, and G4_{avg}=70.9%.

Within each group, there is a minimum SOC. The minimum SOCs for groups G1, G2, G3 and G4 are SOC2, SOC5, SOC7 and SOC10, respectively. A SOC that is a global minimum for the entire battery cells C1-Cm is selected as a target SOC. In the example of FIG. 5, SOC5 is the global minimum and is thus selected as the target SOC. The group that includes the target SOC (G2) is referred to herein as the target group.

In one embodiment, a group minimization stage is used to set all of the minimum SOCs of each group to the target SOC. This is the method disclosed in boxes 418, 420, 422 and 424 of FIG. 4. In the individual cell minimization state, all of the remaining SOCs are lowered to the target SOC.

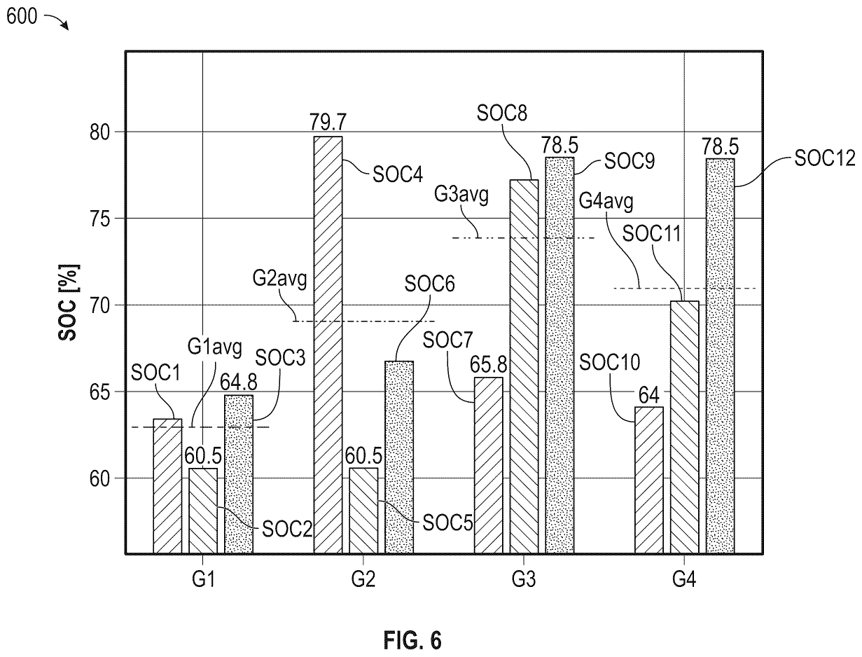

FIGS. 6-8 show subsequent steps of the group minimization stage. For each of the non-target groups (i.e., G1, G3 and G4), the groups are ordered in a first sequence from the highest minimum SOC to the lowest minimum SOC. For the example of FIG. 5, the first sequence G1, G3, G4. The SOCs of each of the modules are then reduced in the order presented in the first sequence to equalize the minimum SOCs.

FIG. 6 is a graph 600 showing a first step in which group G1 is reduced. All of the SOCs of G1 (i.e., SOC1, SOC2, SOC3) are reduced by the same amount until the minimum SOC of the group (i.e., SOC2) is equal to the target SOC. As a result of this first step, the average SOC of G1 is reduced to G1_{avg}=62.9%.

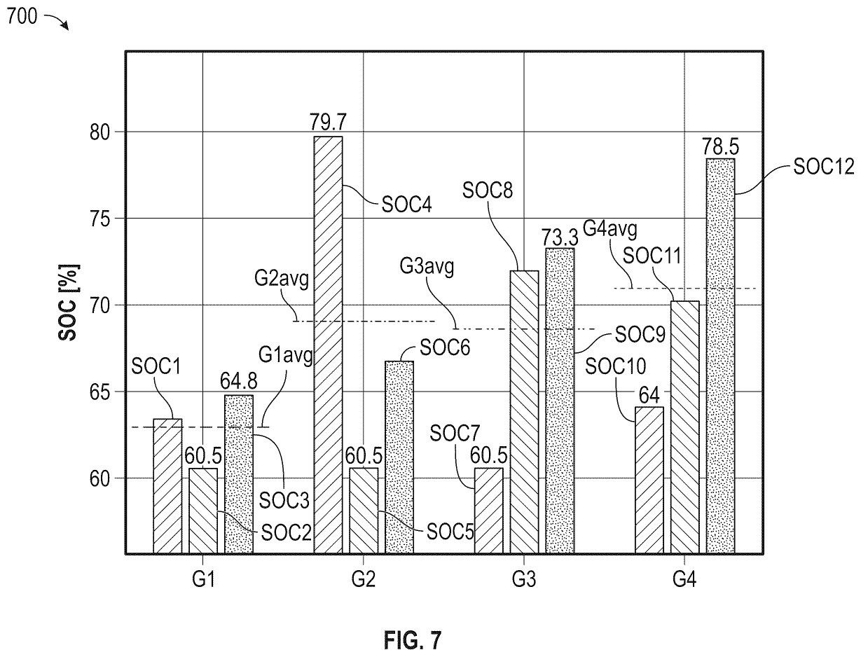

FIG. 7 is a graph 700 showing a second step. All of the SOCs of G3 (i.e., SOC7, SOC8, SOC9) are reduced by the same amount until the minimum SOC of the group (i.e., SOC7) is equal to the target SOC. As a result of this second step, the average SOC of G3 is reduced to G3_{avg}=68.6%.

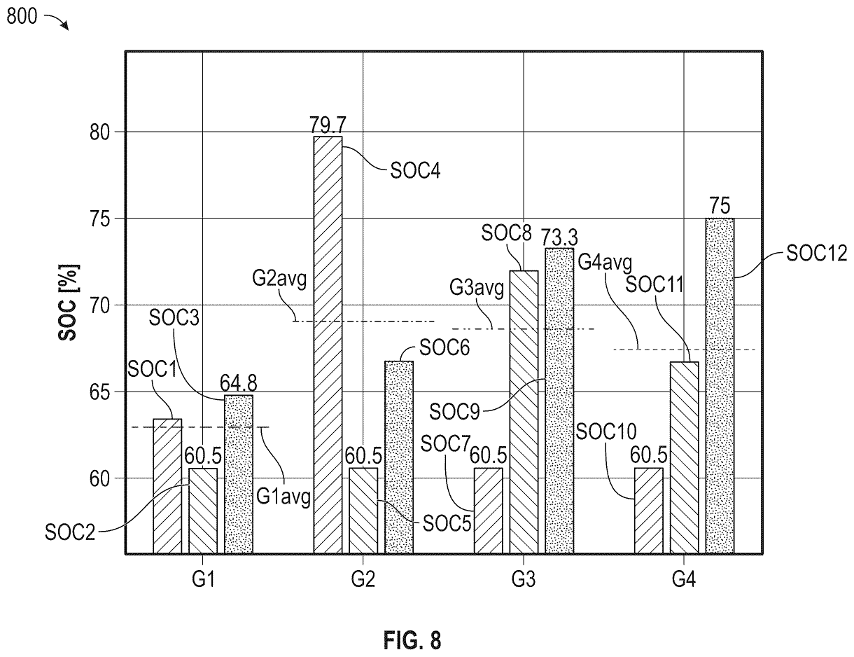

FIG. 8 is a graph 800 showing a third step. All of the SOCs of G4 (i.e., SOC10, SOC11, SOC12) are reduced by the same amount until the minimum SOC of the group (i.e., SOC10) is equal to the target SOC. As a result of this third step, the average SOC of G4 is reduced to G4avg=67.4%.

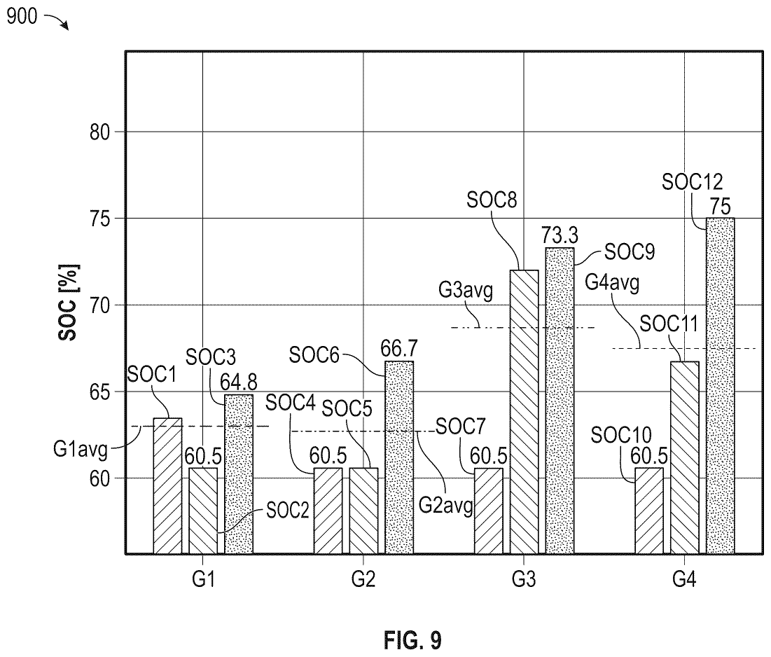

FIGS. 9-16 shows steps in a subsequent individual cell minimization stage. In this stage, the remaining SOCs are adjusted to equal the target SOC. The remaining SOCs (SOC1, SOC3, SOC4, SOC6, SOC8, SOC9, SOC11, SOC12) are ordered in a second sequence from highest to lowest. For the SOCs shown in FIG. 8, the second sequence is SOC4, SOC12, SOC9, SOC8, SOC6, SOC11, SOC3, SOC1. The SOCs are then individually reduced to the target SOC (without affecting the other SOCs in the associated module. The SOCs are reduced according to the order of the second sequence.

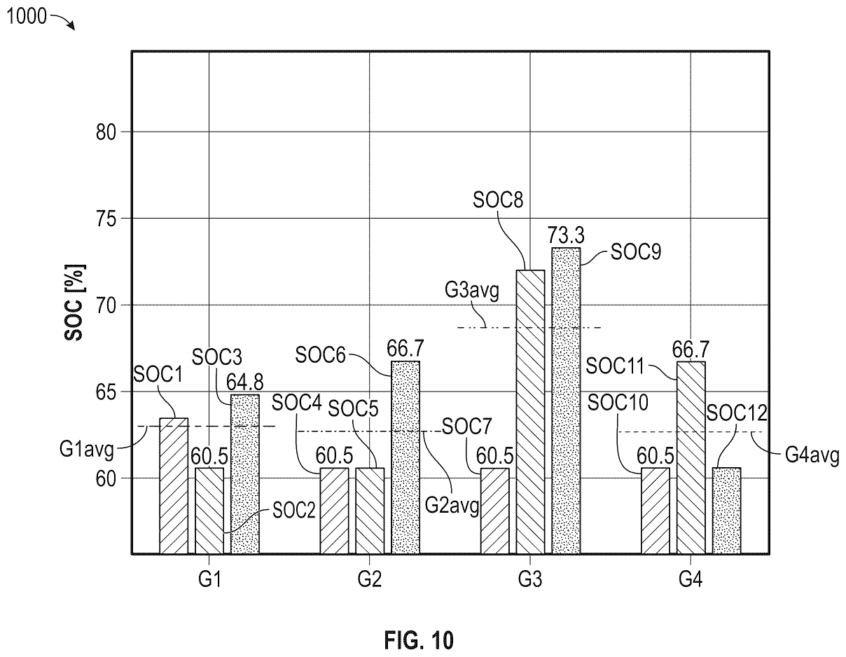

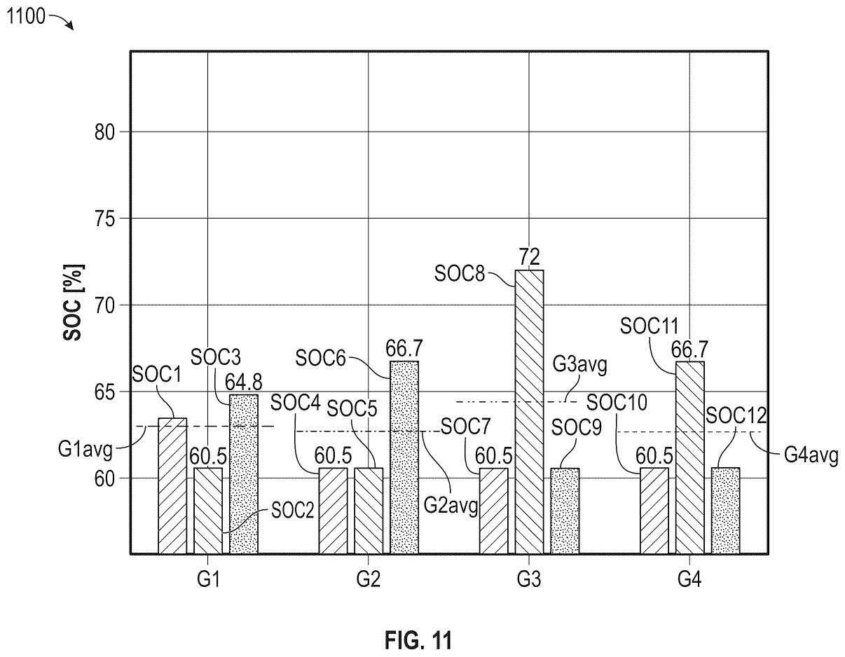

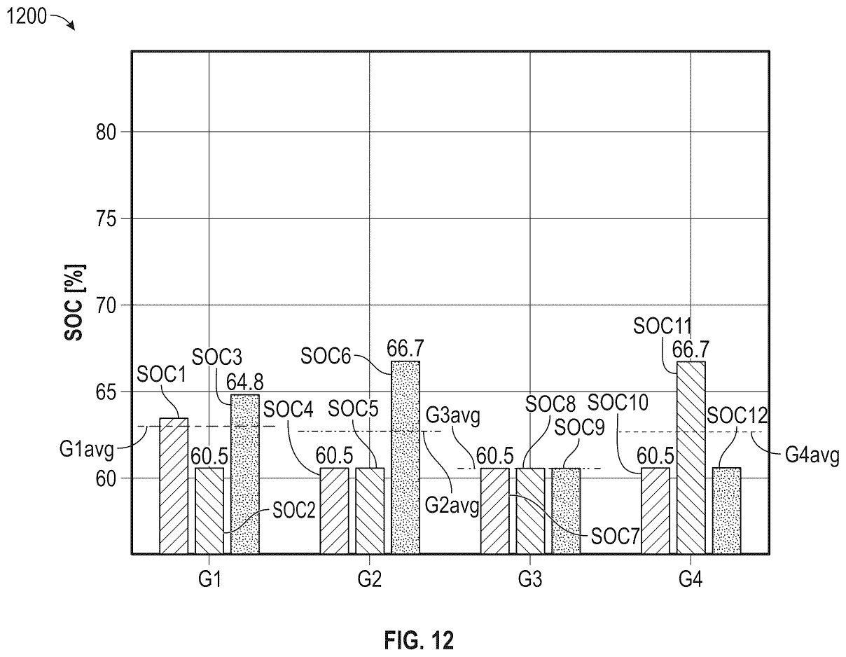

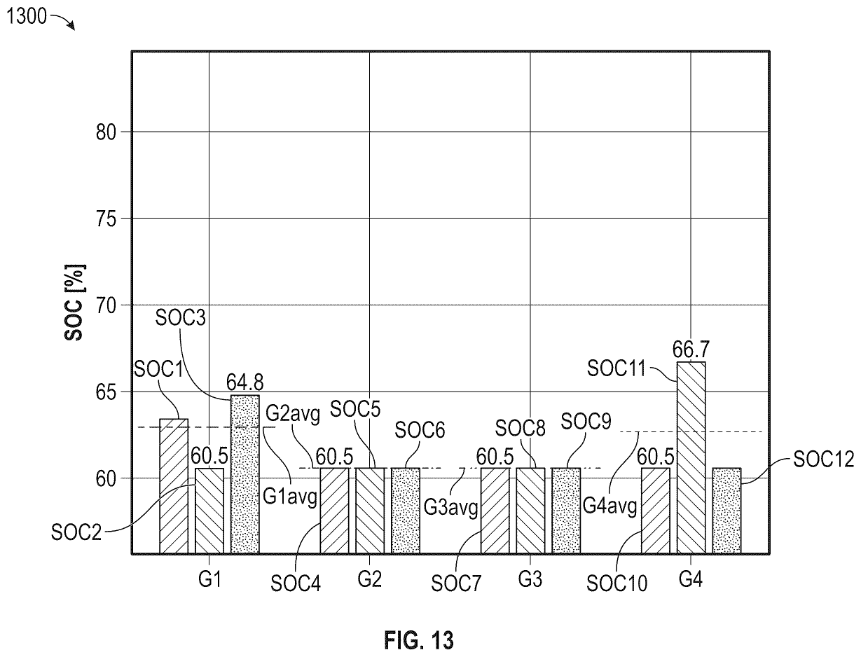

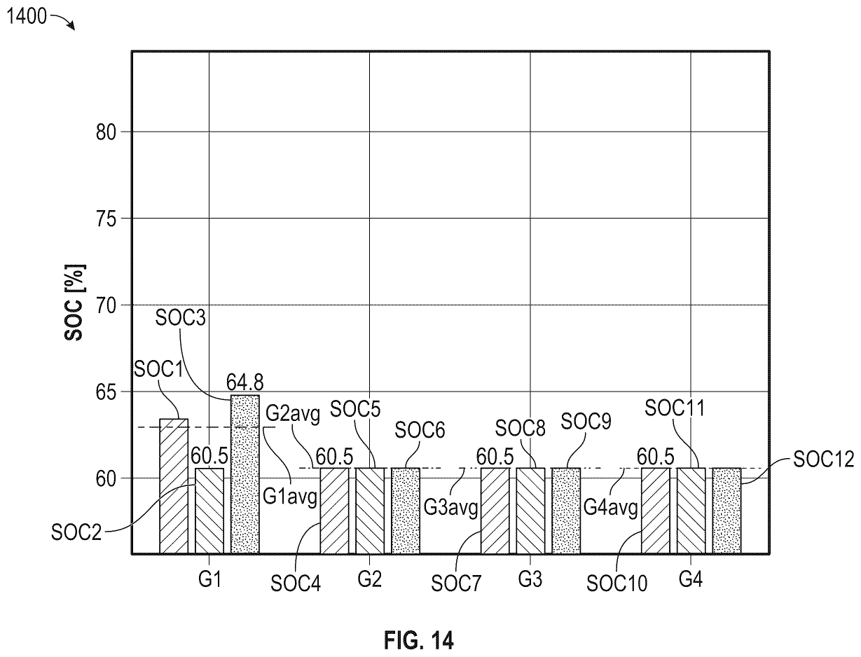

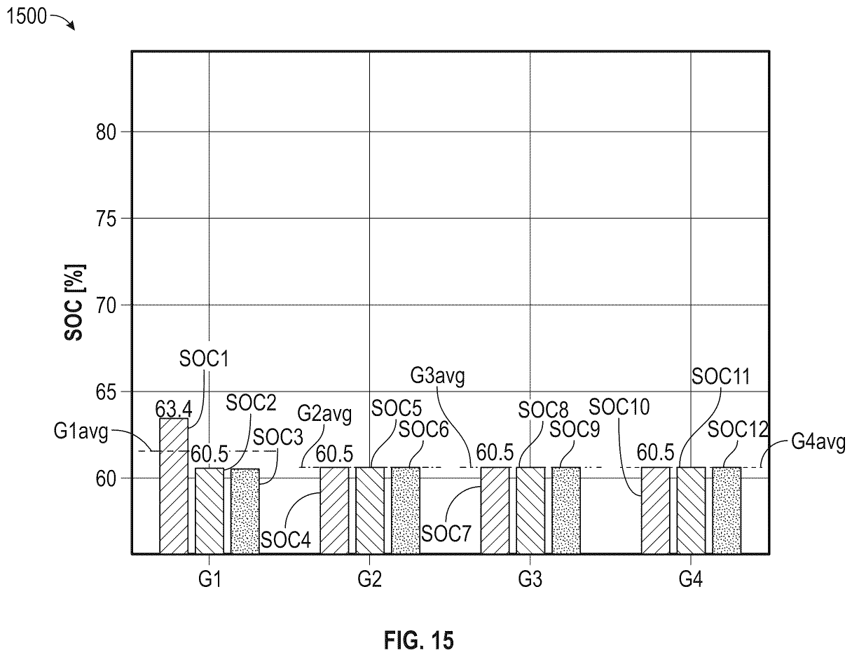

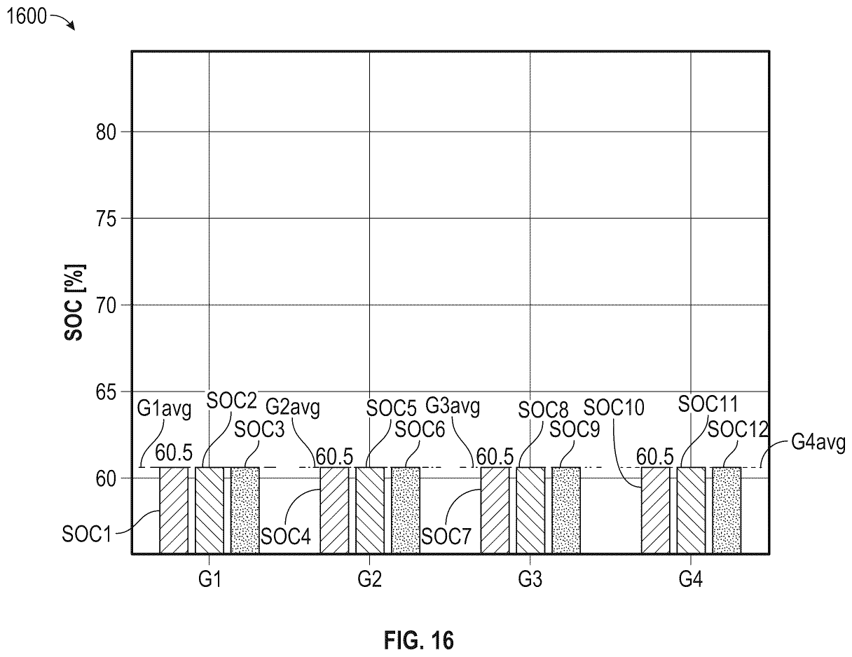

FIG. 9 is a graph 900 showing a first step in the individual cell minimization stage. SOC4 is reduced to the target SOC. FIG. 10 is a graph 1000 showing a second step in the individual cell minimization stage in which SOC12 is reduced to the target SOC. FIG. 11 is a graph 1100 showing a third step in the individual cell minimization stage in which SOC9 is reduced to the target SOC. FIG. 12 is a graph 1200 showing a fourth step in the individual cell minimization stage in which SOC8 is reduced to the target SOC. FIG. 13 is a graph 1300 showing a fifth step in the individual cell minimization stage in which SOC6 is reduced to the target SOC. FIG. 14 is a graph 1400 showing a sixth step in the individual cell minimization stage in which SOC11 is reduced to the target SOC. FIG. 15 is a graph 1500 showing a seventh step in the individual cell minimization stage in which SOC3 is reduced to the target SOC. FIG. 16 is a graph 1600 showing an eighth step in the individual cell minimization stage in which SOC1 is reduced to the target SOC. At the end of individual cell minimization stage all of the SOCs are at the target SOC.

FIG. 17 is a flowchart 1700 of a second method for adjusting the SOCs of the battery cells of a battery pack, in one embodiment. The method starts at box 1702. In box 1704, background functions of the battery controller 306 are initiated. Initiation includes performing checks, handshakes, etc. In box 1706, the regulators 308a-308n are initialized at default parameters for controlling the DC/DC converters. In box 1708, the battery managers 310a-310m are initialized at default parameters for controlling switches and battery selection. Once initialized, the regulators and battery managers are operated in the background for the remainder of the method, thereby providing the data for subsequent steps. In box 1710, battery parameters (e.g., voltage, current, temperature) are acquired or sensed using the battery managers 310a-310m. In box 1712, the battery controller 306 estimates the battery states (e.g., SOC, state of health (SOH)) for each battery cell based on the battery parameters. In box 1714, a target battery state is identified. The target battery state can be a global minimum SOC of the battery cells. The battery cell that has the target battery state is identified as a target battery. In box 1716, the group that includes the target battery is identified as the target group.

In box 1718, a target SOC is identified from the batteries in the target group. In box 1720, the battery managers are controlled to adjust the SOCs within each battery group to a target. The relative SOC relation between the battery cells in each group is maintained, thereby changing the average for the group. In an embodiment, the SOCs are adjusted in lock step with each other until a selected SCO (such as the minimum SOC) of the group equals the target SOC (i.e., the global minimum). In box 1722, it is determined whether the groups have reached their target. If the groups have not reached their target, the method loops back to box 1720. Otherwise, the method proceeds to box 1724.

In box 1724, a desired mode of operation of a regulator is determined. This includes determining various parameters of the regulators, such as a charging time (Tₒₙ), a reference current (I_{ref}), a reference voltage (V_{ref}), a charging time limit (Tₗᵢₘᵢₜ) and a power limit (Pₗᵢₘᵢₜ).

In box 1726, the regulators are selected and enabled (while the battery states are enabled). The regulators adjust the battery cells of each group by a same amount until a condition is met, such as the minimum SOC of the group matching the target SOC. In box 1728, the condition is checked. If not all of the battery cells have reach the target SOC, the method loops back to box 1726. Otherwise, the method proceeds to box 1730. In box 1730, the method ends.

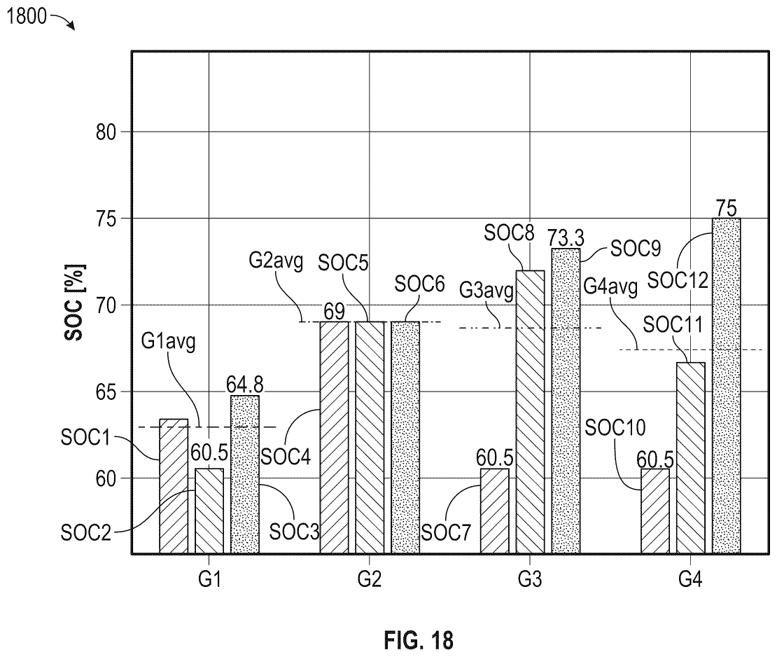

In another embodiment, the SOCs of the cells are adjusted to group averages. The group minimization stage (FIGS. 5-8) is following by a group average equalization stage. FIGS. 18-21 show the steps of the group average equalization stage. For each group, a maximum SOC value is estimated. The groups are ordered in a sequence from highest maximum SOC at the end of the group minimization stage to lowest maximum SOC at the end of the group minimization stage. Based on the maximum SOCs in FIG. 10, the sequence is G2, G4, G3, G1.

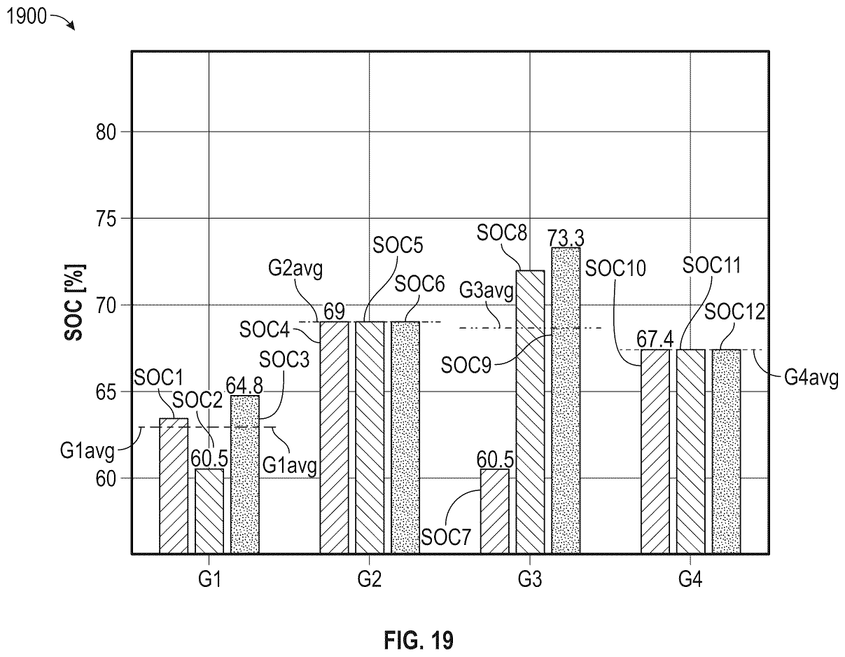

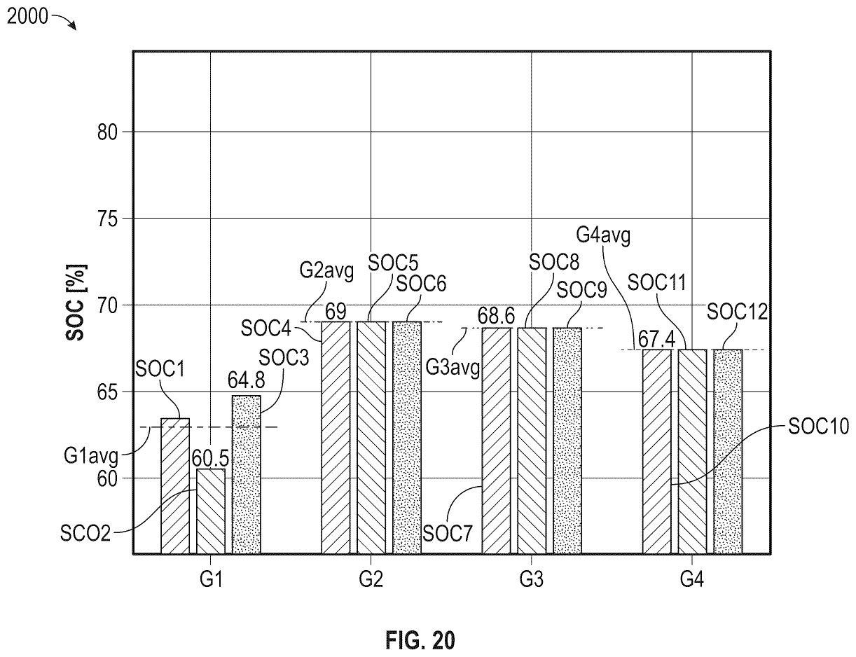

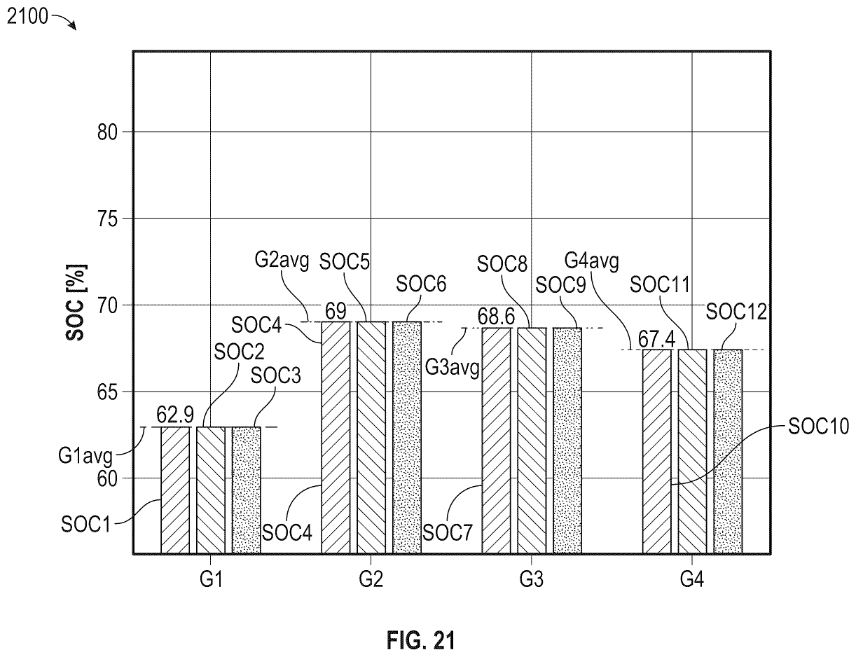

FIG. 18 is a graph 1800 showing first step of the group average equalization stage. SOC4, SOC5 and SOC6 are all charged (or discharged) to G2avg=69%. FIG. 19 is a graph 1900 showing a second step of the group average equalization stage. SOC10, SOC11 and SOC12 are all charged (or discharged) to G4avg=67.4%. FIG. 20 is a graph 2000 showing a third step of the group average equalization stage. SOC7, SOC8 and SOC9 are all charged (or discharged) to G2avg=69%. FIG. 21 is a graph 2100 showing a fourth step of the group average equalization stage. SOC1, SOC2 and SOC3 are all charged (or discharged) to G1avg=62.9%.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of balancing battery cells in a battery pack, comprising:
estimating a state of charge (SOC) of each battery cell of the battery pack, wherein the battery cells are grouped into a plurality of groups;
identifying a target battery cell having a global minimum SOC from amongst the battery cells, wherein the global minimum SOC is a target SOC;
identifying a target group from the plurality of groups that includes the target battery cell;
identifying a non-target group that does not include the target battery cell;
balancing the battery cells by:
reducing the SOC of the battery cells of the non-target groups until a minimum SOC of the non-target group is equal to the target SOC by removing a same SOC from each battery cell in the non-target group, and
adjusting the SOC of the battery cells within the non-target group to meet a selected group target for the non-target group.

2. The method of claim 1, wherein the non-target group includes multiple non-target groups, further comprising reducing the SOC of the battery cells of the non-target group until the minimum SOC of the non-target group is equal to the target SOC by one of: (i) reducing the SOC of the battery cells of each non-target group simultaneously; and (ii) reducing the SOC of the battery cells in each non-target group in an order from the non-target group having a highest minimum SOC to the non-target group having a lowest minimum SOC.

3. The method of claim 1, wherein adjusting the SOCs of the non-target group to meet the selected group target further comprises one of: (i) reducing each SOC of the non-target group to the target SOC; and (ii) adjusting the SOC of each battery cell of the non-target group to a group average.

4. The method of claim 3, wherein reducing each SOC of the non-target group to the target SOC further comprises one of: (i) reducing the SOCs simultaneously; and (ii) reducing the SOCs in an order from a maximum SOC to a minimum SOC.

5. The method of claim 1, wherein the battery pack includes four battery groups and each battery group including three battery cells.

6. The method of claim 1, further comprising operating a battery manager to control a configuration of a switch at a selected battery cell and operating a regulator to control operation of a converter associated with a selected group.

7. The method of claim 1, further comprising identifying a maximum SOC of the battery pack and a minimum SOC of the battery pack and balancing the battery pack when a difference between the maximum SOC and the minimum SOC is greater than a threshold.

8. A system for balancing battery cells of a battery pack, comprising:
a plurality of battery managers, each battery manager configured to estimate a state of charge (SOC) of a battery cell of the battery pack, wherein the battery cells are grouped into a plurality of groups;
a plurality of regulators, each regulator configured to control a group of the plurality of groups;
a processor configured to:
identify a target battery cell having a global minimum SOC from amongst the battery cells, wherein the global minimum SOC is a target SOC;
identify a target group from the plurality of groups that includes the target battery cell;
identify a non-target group that does not include the target battery cell;
balancing the battery cells by:
reducing the SOC of the battery cells of the non-target group until a minimum SOC of the non-target group is equal to the target SOC by removing a same SOC from each battery cell in the non-target group; and
adjusting the SOC of the battery cells within the non-target group to meet a selected group target for the non-target group.

9. The system of claim 8, wherein the non-target group includes multiple non-target groups and the processor is further configured to reduce the SOC of the battery cells of the non-target group until the minimum SOC of the non-target group is equal to the target SOC by performing one of: (i) reducing the SOC of the battery cells of each non-target group simultaneously; and (ii) reducing the SOC of the battery cells in each non-target group in an order from the non-target group having a highest minimum SOC to the non-target group having a lowest minimum SOC.

10. The system of claim 8, wherein the processor is further configured to adjust the SOCs of the non-target group to meet the selected group target by performing one of: (i) reducing each SOC of the non-target group to the target SOC; and (ii) adjusting the SOC of each battery cell of the non-target group to a group average.

11. The system of claim 10, wherein the processor is further configured to reduce each SOC of the non-target group to the target SOC by performing one of: (i) reducing the SOCs simultaneously; and (ii) reducing the SOCs in an order from a maximum SOC to a minimum SOC.

12. The system of claim 11, wherein the battery pack includes four battery groups and each battery group including three battery cells.

13. The system of claim 8, wherein the processor is further configured to operate a battery manager selected from the plurality of battery managers to control a configuration of a switch at a selected battery cell and operate a regulator selected from the plurality of regulators to control operation of a converter associated with a selected group.

14. The system of claim 8, wherein the processor is further configured to identify a maximum SOC of the battery pack and a minimum SOC of the battery pack and balance the battery pack when a difference between the maximum SOC and the minimum SOC is greater than a threshold.

15. A vehicle, comprising:
a vehicle controller in communication with a plurality of battery managers and a plurality of regulators, each battery manager configured to estimate a state of charge (SOC) of a battery cell of a battery pack, wherein the battery cells are grouped into a plurality of groups and a plurality of regulators, each regulator configured to control a group of the plurality of groups;
a processor configured to:
identify a target battery cell having a global minimum SOC from amongst the battery cells, wherein the global minimum SOC is a target SOC;
identify a target group from the plurality of groups that includes the target battery cell;
identify a non-target group that does not include the target battery cell;
balance the battery cells by:
reducing the SOC of the battery cells of the non-target group until a minimum SOC of the non-target group is equal to the target SOC by removing a same SOC from each battery cell in the non-target group; and
adjusting the SOC of the battery cells within the non-target group to meet a selected group target for the non-target group.

16. The vehicle of claim 15, wherein the non-target group includes multiple non-target groups and the processor is further configured to reduce the SOC of the battery cells of the non-target group until the minimum SOC of the non-target group is equal to the target SOC by performing one of: (i) reducing the SOC of the battery cells of each non-target group simultaneously; and (ii) reducing the SOC of the battery cells in each non-target group in an order from a non-target group having the highest minimum SOC to the non-target group having a lowest minimum SOC.

17. The vehicle of claim 15, wherein the processor is further configured to adjust the SOCs of the non-target group to meet the selected group target by performing one of: (i) reducing each SOC of the non-target group to the target SOC; and (ii) adjusting the SOC of each battery cell of the non-target group to a group average.

18. The vehicle of claim 17, wherein the processor is further configured to reduce each SOC of the non-target group to the target SOC by performing one of: (i) reducing the SOCs simultaneously; and (ii) reducing the SOCs in an order from a maximum SOC to a minimum SOC.

19. The vehicle of claim 15, wherein the battery pack includes four battery groups and each battery group including three battery cells.

20. The vehicle of claim 15, wherein the processor is further configured to operate a battery manager selected from the plurality of battery managers to control a configuration of a switch at a selected battery cell and operate a regulator selected from the plurality of regulator to control operation of a converter associated with a selected group.
